(19) United States
(12) Patent Application Publication
(10) Pub. No.: US 2017/0053097 A1
(43) Pub. Date: Feb. 23, 2017

(54) ADHERENCE-BASED UTILIZATION MANAGEMENT

(71) Applicant: Aetna Inc., Hartford, CT (US)

(72) Inventors: Henry George Wei, Larchmont, NY (US); Shawn Edmonds, Belle Mead, NJ (US); Tammie K. McGonigle, Phoenixville, PA (US); Kamal Patel, Southington, CT (US); Julia Elizabeth Thomas, St. Paul, MN (US)

(21) Appl. No.: 15/241,746

(22) Filed: Aug. 19, 2016

Related U.S. Application Data
(60) Provisional application No. 62/208,354, filed on Aug. 21, 2015.

(51) Int. Cl. G06F 19/00

(52) U.S. Cl. CPC G06F 19/3456; G06F 19/345

(57) ABSTRACT

An embodiment of the disclosure provides a method for performing claim adjudication by an adherence server. The adherence server includes a non-transitory computer readable medium and a processor to execute computer executable instructions stored on the non-transitory computer readable medium, so that when the instructions are executed, the adherence server performs the method of: (a) receiving adherence data describing a patient's adherence to a prescribed medication; (b) determining an adherence level for the patient using the received adherence data; (c) comparing the adherence level to an adherence threshold; and (d) providing, to a second device, an adherence decision based on the comparison between the adherence data and the adherence threshold.

### CROSS REFERENCE TO RELATED APPLICATIONS

The application claims the benefit of U.S. Provisional Patent Application Ser. No. 62/208,354, filed on Aug. 21, 2015, which is incorporated by reference.

### BACKGROUND

A significant challenge in healthcare today is that frequently patients do not take medications as prescribed. It is estimated that for certain types of medications, adherence levels are as low as 50%. Once medication adherence falls below a certain value (ex: 80% in statins) the medication loses its effectiveness. This has multiple negative impacts for the patient and the healthcare system overall: (1) patients are at risk for having a significant adverse health event that would otherwise be avoidable leading to detrimental impacts to their health and significant claims costs; (2) waste in the system since the medication is being paid for but not providing the desired result due lack of medication adherence; and (3) additional or escalated therapies may be prescribed to try to address the original condition when it would be unnecessary if the medication was taken as prescribed, which drives increased costs and other potentially negative health impacts due to additional side effects associated with layering on additional or escalated therapies.

### SUMMARY

An embodiment of the disclosure provides a method for performing claim adjudication by an adherence server. The adherence server includes a non-transitory computer readable medium and a processor to execute computer executable instructions stored on the non-transitory computer readable medium, so that when the instructions are executed, the adherence server performs the method of: (a) receiving adherence data describing a patient's adherence to a prescribed medication; (b) determining an adherence level for the patient using the received adherence data; (c) comparing the adherence level to an adherence threshold; and (d) providing, to a second device, an adherence decision based on the comparison between the adherence data and the adherence threshold.

Another embodiment of the disclosure provides a non-transitory computer readable medium containing computer executable instructions for causing an adherence server performing claim adjudication to perform the method of: (a) receiving adherence data describing a patient's adherence to a prescribed medication; (b) determining an adherence level for the patient using the received adherence data; (c) comparing the adherence level to an adherence threshold; and (d) providing, to a second device, an adherence decision based on the comparison between the adherence data and the adherence threshold.

Yet another embodiment of the disclosure provides a system to perform claim adjudication. The system includes an adherence server, a claims server, and a database. The adherence server includes a processor and a memory with program instructions for causing the adherence server to perform the method of: (a) receiving adherence data describing a patient's adherence to a prescribed medication, (b) determining an adherence level for the patient using the received adherence data, (c) comparing the adherence level to an adherence threshold, and (d) determining an adherence decision based on the comparison between the adherence level and the adherence threshold, wherein the adherence decision comprises a positive adherence when the adherence level is greater than or equal to the adherence threshold and a negative adherence decision when the adherence level is less than the adherence threshold. The claims server includes a processor and a memory containing program instructions for causing the claims server to perform the method of: (a) receiving a claim request associated with the patient, and (b) performing claims adjudication using information in the claim request and the adherence decision such that when the adherence decision is a positive adherence decision the claim request is granted and when the adherence decision is a negative adherence decision the claim request is denied. The database is configured to store the adherence data, the adherence decision, the claim request, and additional patient data.

### BRIEF DESCRIPTION OF THE DRAWING

FIG. 1 illustrates a system that incorporates adherence-based utility management according to an example embodiment;

FIG. 2 illustrates a flow diagram showing steps involved in a precertification procedure according to an embodiment of the disclosure;

FIG. 3 illustrates a flow diagram showing steps involved in a claim adjudication process according to an embodiment of the disclosure;

FIG. 4 illustrates a flow diagram showing steps for adherence determination according to an embodiment of the disclosure; and

FIG. 5 illustrates an electronic device according to an embodiment of the disclosure.

### DETAILED DESCRIPTION

Disclosed herein is a method for adjudicating claims decisions for second, third, and later-line drugs and agents that utilize existing precertification requirements, but inserts a determination of medication adherence level, decision support for the claim or approval request using new novel approaches, and finally provides a recommendation on improvement of adherence if needed. This process can be described as adherence-based utilization management. Adherence-based utilization management introduces a check mechanism, process and technology to prompt, as well as calculate and/or corroborate whether or not a patient is taking their medication as prescribed (medication adherence level) prior to approving a second-line or other escalated drug agent for reimbursement.

The determination of medication adherence level will be accomplished by leveraging one or more of the following methods: (1) leveraging data from sensor devices capable of directly recording and transmitting data related to the administration of medication; (2) leveraging data captured via mobile applications that allow a patient to record the administration of medication in various forms; (3) leveraging claims data to calculate adherence levels; and (4) physician attestations as to the adherence level of a patient.

Medication adherence data that is captured will be transmitted via various secure methods. The data will then be used in combination with previous claims data to verify and/or calculate the medication adherence level of the patient for that medication. Precertification and claim reimbursement decisions for the additional or escalated therapy will be made based on these calculations and clinical policy. If medication adherence levels are met, the additional or escalated therapy will be authorized for payment depending on the patient's health plan. For claims denials due to low levels of medication adherence, appropriate outreach to improve medication adherence will be performed.

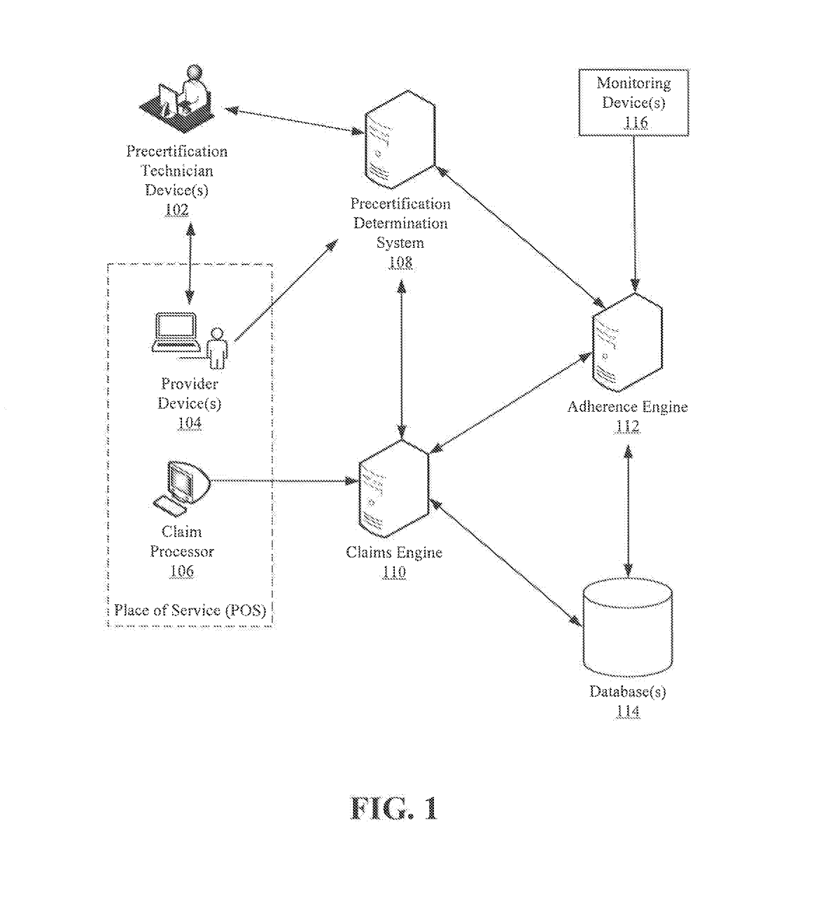

FIG. 1 illustrates a healthcare management system 100 that incorporates adherence-based utility management according to an example embodiment. The healthcare management system 100 includes precertification technician device(s) 102, a precertification determination system 108, a claims engine 110, one or more monitoring device(s) 116, an adherence engine 112, one or more database(s), and a place of service (POS) where a patient receives healthcare service. The POS may include a claim processor 106 and one or more provider device(s) 104. Without loss of generality and for simplicity in explanation, the singular form of device and database will be used except in example situations where the plural forms are more appropriate, but it is understood that multiple devices or a collection of devices may be referred to as precertification technician device, monitoring device, or provider device, and multiple databases may be referred to as database.

The precertification technician device 102, the provider device 104, and the claim processor 106 all have underlying hardware that enable communication, processing, data and command storage, and information flow. These hardware may include a microcontroller or a processor, a non-transitory computer readable medium, network interfaces, etc. Exemplary devices include a smartphone, tablet, phablet, and other computing devices such as laptops and desktops. Provider device 104 and claim processor 106 are shown as separate entities, but in some embodiments, the same device is shared to perform functionality attributed to both. Examples of the POS include a pharmacy, a clinic, a healthcare facility, a hospital, etc.

Monitoring device 116 includes sensor devices capable of directly recording and transmitting data related to the administration of medication in various forms including oral, inhaled, injected and infused medications. Examples of sensor devices include asthma inhaler smart caps, embedded pill sensors, “smart” pill bottles, “smart” auto-injectors, etc. The sensor devices may record and transmit data including date, time, dose, location, etc. Monitoring device 116 may also include mobile devices, for example, smartphone, tablet, phablet, etc. The mobile devices may run mobile applications that allow a patient to record administration of medication in various forms and transmit such data to the adherence engine 112.

The precertification determination system 108, claims engine 110, and adherence engine 112 are shown as computer servers in FIG. 1. Each of these entities may be implemented using one or more computer servers with underlying hardware that enable communication, processing, data and command storage, and information flow. FIG. 1 is meant to identify functionality attributed to each of the precertification determination system 108, claims engine 110, and adherence engine 112 and not necessarily their physical separation or location.

Database 114 serves to provide additional storage for the healthcare management system 100. Database 114 may store claims data and calculated adherence levels from prior claims data history by proportion of days covered or by medication possession ratio. Database 114 may also store parameters pertaining to plan benefit to enable the claims engine 110 to determine whether a patient or member identification in a submitted claim is eligible for certain benefits.

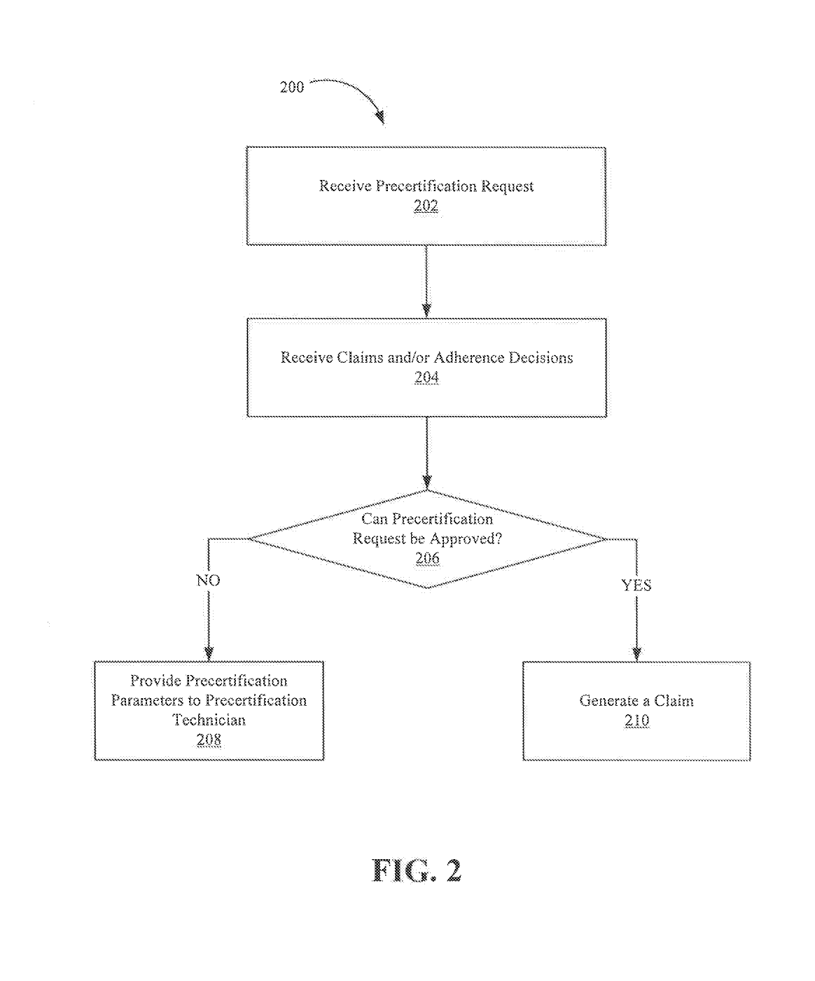

FIG. 2 illustrates a flow diagram showing steps involved in a precertification procedure 200 performed at the precertification determination system 108 according to an embodiment of the disclosure. Precertification may be achieved by a doctor checking to see whether a certain drug can be precertified. In some cases, the doctor is being proactive in checking to see if he/she can prescribe a drug, and in other cases, the precertification is related to a canceled claim. At step 202, a precertification request is received at the precertificaiton determination system 108. The precertification request may be received from the provider device 104. For example, the provider device 104 may electronically submit the request to the precertification determination system 108. In an embodiment, a doctor may want to check whether a certain drug can be precertified, so the doctor sends a precertification request through a desktop computer to the precertification determination system 108. In some embodiments, the precerfication request is received from a precertification technician device 102. For example, a provider device 104 may be used by a doctor to contact a precertification technician. The precertification technician would then use the precertification technician device 102 to generate a precertification request on behalf of the doctor. The precertification technician device 102 would then send the precertification request to the precertification determination system 108.

At step 204, the precertification determination system 108 may receive claim decisions from the claims engine 110 and/or adherence decisions from the adherence engine 112. In some instances, the precertification determination system 108 receives claims decisions from claims engine 110 when the precertification request is related to a specific claim that had been rejected. For example, a claim was submitted to the claims engine 110 through the claim processor 106, and the claim was rejected, so the doctor makes a call to a precertification technician in order to provide additional information in a precertification request. In some instances, the precertification determination system 108 receives adherence decision from the adherence engine 112 after providing additional adherence information embedded in the precertification request to the adherence engine 112. The additional adherence information in combination with other inputs to the adherence engine 112 would be used to make the adherence decisions.

At step 206, the precertification determination system 108 determines whether the precertification request can be approved. This step involves using the adherence decision received from the adherence engine 112 to determine whether the precertification request is approved. In some embodiments, if a claims decision is received as well at step 204, this information may be combined with the adherence decision to determine whether or not to approve the precertification request.

At step 208, if the precertification request is denied, then precertification parameters are provided to the precertification technician device 102. In some cases, when the denial of the precertification request is due to poor adherence, the precertification parameters include adherence levels compared to adherence thresholds that informed the adherence decision. In some embodiments, the precertification parameters include recommended actions for improving adherence levels. The precertification technician may then relay through the precertification technician device 102 the denial of the precertification request to the provider device 104.

At step 210, if the precertification request is approved, then a claim is generated. The claim process follows standard procedure for claim approval based on various factors, for example, a patient's current health plan, generic drug vs. brand name drug, in-network vs. out of network provider, etc.

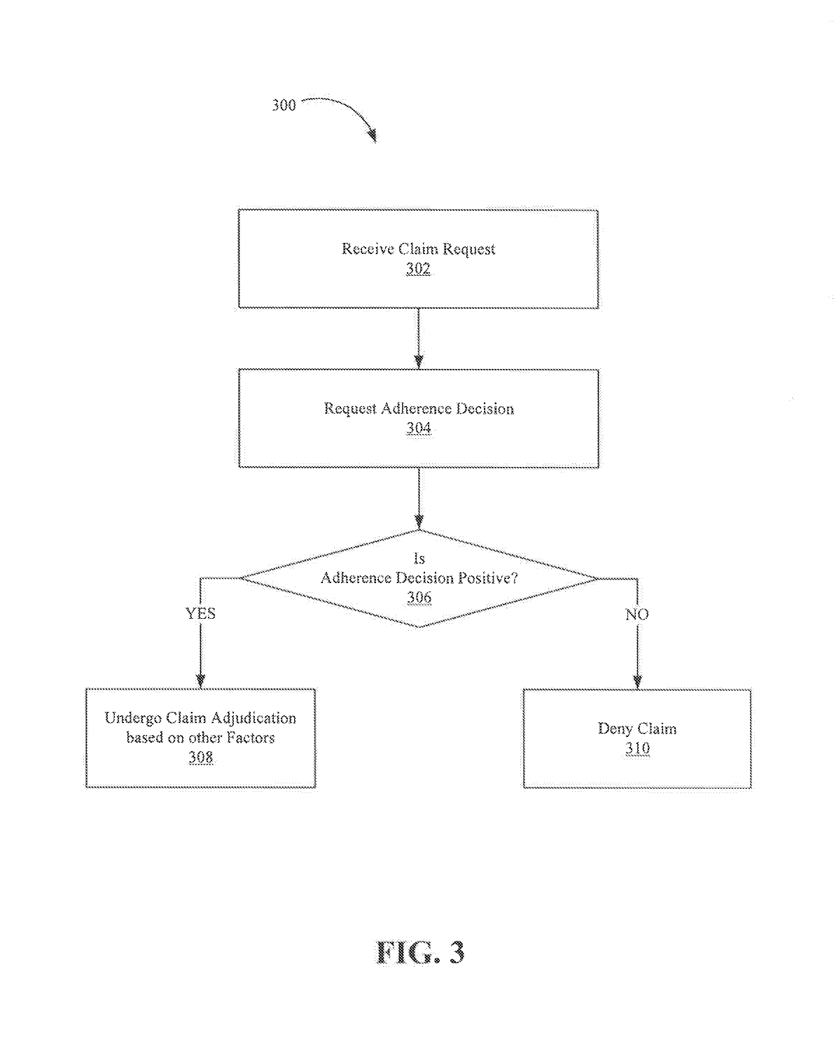

FIG. 3 illustrates a flow diagram showing steps involved in a claim adjudication process 300 performed by the claims engine 110 according to an embodiment of the disclosure. At step 302, the claims engine 110 receives a claim request. The claim request may be sent by the claim processor 106 or automatically generated by the precertification determination system 108 as explained above.

At step 304, the claims engine 110 receives adherence decision from the adherence engine 112. In some embodiments, this step involves a request sent by the claims engine 110 to the adherence engine 112 for adherence information to determine whether to attempt claims adjudication based on other factors. The request may include member identification information and related treatment information so adherence engine 112 is able to properly provide a relevant adherence decision. For example, a member may have two identified conditions, migraines and asthma, but a claim is being directed at treatment for the asthma condition. The member may not be vigilant in taking the medications or treatments prescribed for the migraine condition but is on an acceptable schedule with respect to the asthma treatments. The adherence engine 112 can differentiate between the two conditions and determine that the member has a high adherence level for the asthma treatments thus providing a positive adherence decision.

At step 306, the claims engine determines whether the adherence decision is positive. If the adherence decision is negative, then the claim is denied at step 310. If the adherence decision is positive, then the claim may undergo claim adjudication based on other factors, for example, a patient's current health plan, generic drug vs. brand name drug, in-network vs. out of network provider, etc.

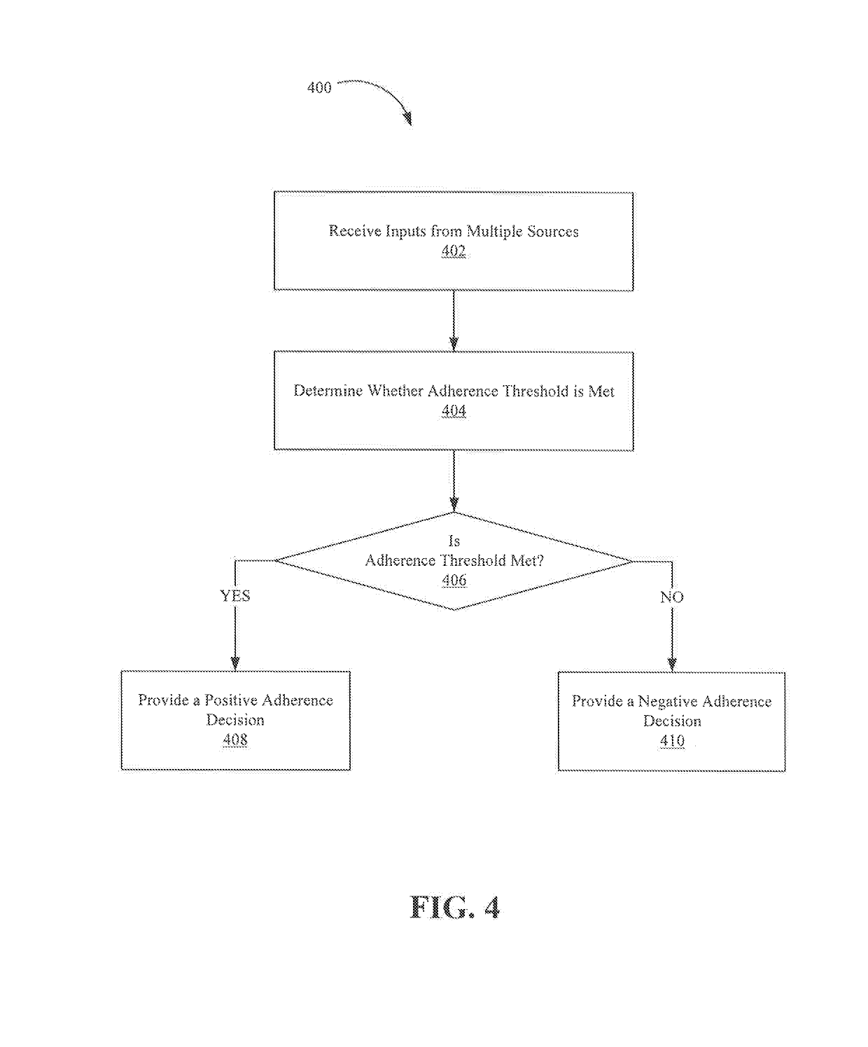

FIG. 4 illustrates a flow diagram showing steps for an adherence determination process 400 performed by the adherence engine 112 according to an embodiment of the disclosure. The precertification procedure 200 and the claim adjudication process 300 have been shown to receive and use adherence decisions. The adherence determination process 400 provides the adherence decisions that inform the already described process 300 and procedure 200. At step 402, the adherence engine 112 receives inputs from multiple sources. The adherence engine 112 may receive inputs from monitoring device 116. As previously mentioned, these inputs may include measurement data from an asthma inhaler that tracks use, a “smart” cap for a pill bottle, an embedded pill sensor, a “smart” pill bottle, or a mobile medication adherence tracking application for a mobile device. Any other systems and techniques capable of tracking a patient's adherence to a prescribed medication may be utilized either independently or in addition to the previously mentioned adherence measurement methods and may be classified under monitoring device 116. For example a patient may use a smartphone camera to record a user taking medication. Inputs described so far point to a patient making a decision to take medication and that action being reported to the adherence engine 112. In some embodiments, the monitoring device 116 may report when a patient misses a time window to take medication or when a patient makes up for this miss by taking a larger dose. In these cases, the monitoring device 116 not only sends data regarding the patient taking medication but also provides a timestamp along with the data.

Additionally, at step 402, the adherence engine 112 not only receives inputs from monitoring device 116, but may retrieve from database 114 calculated adherence levels or adherence decisions from prior claims data history. The calculated adherence levels or adherence decisions may be quoted in a proportion of days covered, for example, for a drug that is to be taken 4 times a day for a week, the adherence level may be quoted as 25% out of 40%. The 25% refers to the adherence level viewed in a week's timespan while the 40% refers to the currently elapsed time within the timespan. In some embodiments, the adherence level is not quoted as 25% out of 40% but is instead quoted as 62.5%=25%+40%. The method chosen to code the adherence level may provide different types of information, for example depending on an adherence level of 25% out of 40%, the adherence engine 112 may be able to provide an early signal to a healthcare provider that a patient even when taking the medication for the remaining 60% of the time will not be able to reach an adherence threshold required. In another example, when the adherence level is quoted as 62.5%, the adherence engine 112 may proactively inform a patient or healthcare provider through a precertification technician when the patient falls below the adherence threshold. The adherence level from prior claims may not only be provided as a proportion of days covered but may also be provided as a medication possession ratio. For example, at a given time, the adherence engine 112 is able to track a current amount of the patient's medication as a ratio of a starting amount obtained at a healthcare facility.

In addition to adherence level from prior claims from database 114 and input data from monitoring device 116, at step 402, adherence information may also be provided through the precertification determination system 108. The precertification determination system 108 may relay to adherence engine 112 adherence information obtained from a healthcare provider either through provider device 104 or through precertification technician device 102. For example, a healthcare provider may discover that a patient undergoes really bad side effects or reactions to a medication and wants to prescribe a different medication.

At step 404, using the inputs received from the multiple sources in step 402, the adherence engine 112 determines adherence level. Example formats or coding of the adherence level has been provided in the previous paragraph. In addition, the adherence level may be determined by counting up the number of times a pill bottle has been opened by a patient or the number of pills that have been taken by a patient. Using this data along with a schedule for taking the medication, a ratio may be derived to determine a quantity that signifies adherence level. In some embodiments, the pill data or the inputs received from the multiple sources is stored at database 114 for future calculations.

At step 406, the adherence engine 112 determines whether the determined adherence level in step 404 meets an adherence threshold. The adherence threshold may be different for different medication. For example, a high threshold may be set for antibiotics, for example, 85% but a lower threshold set for pain medication, for example, 50%. In some embodiments, the social impact of the medication is used to set the adherence threshold. For example, not obeying a regimen for antibiotics may result in creating drug-resistant bacteria which may pose health risks to other individuals around the patient. On the other hand, not obeying a regimen for pain medications does not have the same associated social risk so the adherence threshold may be lower. In some embodiments, the impact of the medication to the patient informs the adherence threshold. For example, antibiotics are used to control bacterial growth or treat bacterial infections, so if not treated, the patient is at great risk, and hence the adherence threshold is made high. Pain medication on the other hand is based on the patient's pain threshold, and since some people can bear more pain compared to others, the adherence threshold is lower. The case of pain management is viewed in terms of providing comfort as compared to a bacterial infection which may be life threatening. In some embodiments, the adherence threshold is lowered for a certain medication for a specific patient based on information obtained by a healthcare provider. For example, when it is discovered that a patient is allergic to the medication, the adherence threshold may be lowered to 0% or a very low value.

At step 406, in some embodiments, the adherence engine 112 may store the result of the determination as a “YES” or “NO” based on the adherence level determined at step 404. When storage is limited, the simple “YES” or “NO” may be preferably stored instead of source data from the multiple sources that gave rise to the determination of the adherence level. In some embodiments, both the “YES” and “NO” results along with the source data from the multiple sources are stored for later historical analysis or big data analysis on overall adherence of members to certain types of drugs. When the adherence threshold is met, the adherence engine 112 provides a positive adherence decision at step 408, and when the adherence threshold is not met, the adherence engine 112 provides a negative adherence decision at step 410.

A positive adherence decision is an indication of adherence or compliance to a prescribed treatment regimen. The positive adherence decision may include a “YES” result. The positive adherence decision may also include the adherence level of the member to the treatment and an adherence threshold of the treatment. The positive adherence decision may be different depending on the entity that the adherence engine 112 is providing the positive adherence decision to. For example, when providing the positive adherence decision to the precertification determination system 108, the “YES” result, adherence level, and adherence threshold may be provided so that when the precertification determination system 108 generates a claim, this information is included in the generated claim. Also the precertification determination system 108 may provide this information to the precertification technician device 102 so that the precertification technician may relay this information to the provider device 104. In some embodiments, a positive adherence decision provided to the claims engine 110 may only include a “YES” result allowing the claims engine 110 to perform claim adjudication based on other factors at step 308.

A negative adherence decision is an indication of non-compliance to a prescribed treatment regimen. The negative adherence decision may include a “NO” result. Additionally, the negative adherence decision may also include the adherence level of the member to the treatment and an adherence threshold of the treatment. The negative adherence decision may also include non-compliance interventions such as issued recommendations, assistance and interventions to improve medication adherence. As in the positive adherence decision, the generated decision matches the entity requesting the adherence check. For example, when providing the negative adherence decision to the precertification determination system, the “NO” result is provided, the current adherence level is provided, the adherence threshold is provided, and a message stating that the patient should take the medication for a specified trial period and achieve a specified adherence level during that trial period. When providing negative adherence decision to the claims engine, the “NO” result along with the adherence level and adherence threshold may be provided.

Embodiments of the disclosure provide adherence-based step therapy process for health insurance claim utilization management. The adherence determination process 400 may be triggered by a variety of techniques, including: (1) spontaneous measurement by a provider prior to a claim activity; (2) detecting a new claim submitted by a provider without adherence data, or a request for external data dependent on insurance policy settings; (3) retrospective review of existing and historic claims and adjudication decisions for post-escalation additional therapy; and (4) repeat periodic review as allowed for by a health insurer's reimbursement policy.

Embodiments of the disclosure provide adherence-based step therapy process for health insurance claim utilization management where each medication or treatment a patient is prescribed would be independently. By doing so, each independent treatment may generate its own adherence data, therefore, the ability to intervene separately for separate treatments. Embodiments of the disclosure further provide a member-level adherence-based step therapy where adherence thresholds are not only determined for each individual treatment, but are determined in light of a specific member's health. Thus two members may have a different adherence threshold for the same medication. For example, a member with more severe asthma would be expected to meet an 80% threshold while a member with less severe asthma may be expected to only use his/her asthma inhaler in emergency situations thus placing an adherence threshold of 10% on the medication.

Embodiments of the disclosure provide an option to perform an historical type analysis/big data analysis on overall adherence of members to certain types of drugs. Different member populations may be examined based on various similarities, for example, geography, age, gender, etc.

Embodiments of the disclosure further provide a system that determines adherence to a prescribed medication using adherence data gathered from various sources to determine an adherence level. The adherence level is compared to an adherence threshold. If the adherence level exceeds the adherence threshold, a positive adherence decision is made. A positive adherence decision may be used to approve a claim for a new prescription. When the claim for the escalated prescription is approved, then new policy settings are provided for ongoing monitoring of adherence to that prescription, and the above described process is repeated for the new prescription. New policy settings include an adherence threshold for the new prescription, a new specified trial period and a new specified adherence level for the new specified trial period. Note that specified trial periods and specified adherence levels are used when a patient does not meet adherence thresholds and is on a trial period.

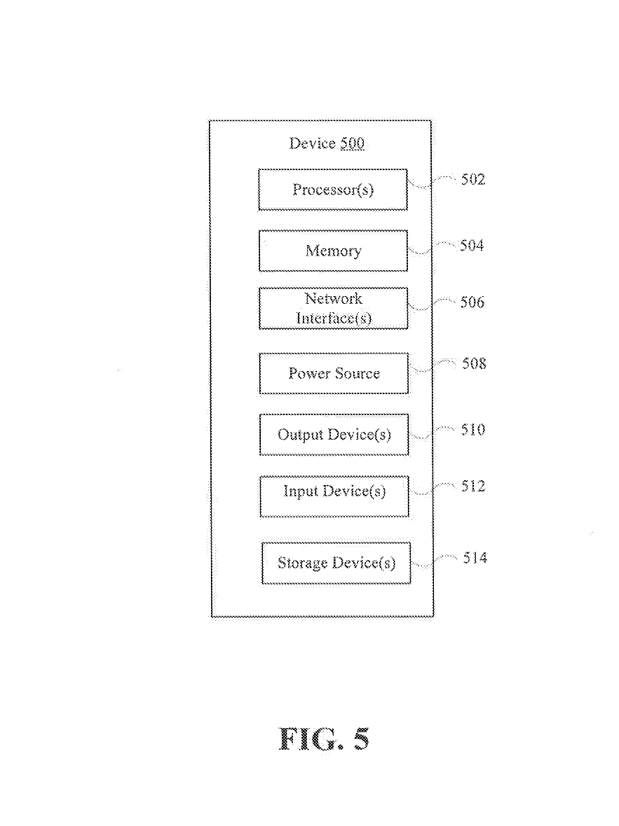

FIG. 5 illustrates an electronic device 500 according to an embodiment of the disclosure. Electronic devices, for example, the monitoring device 116, the precertification determination system 108, the claims engine 110, the adherence engine 112, the database 114, the provider device 104, the claim processor 106, and the precertification technician device 102 may be computer devices. The device 500 may include one or more processors 502, memory 504, network interfaces 506, power source 508, output devices 510, input devices 512, and storage devices 514. Although not explicitly shown in FIG. 5, each component provided is interconnected physically, communicatively, and/or operatively for inter-component communications in order to realize functionality ascribed to the various entities identified in FIG. 1. To simplify the discussion, the singular form will be used for all components identified in FIG. 5 when appropriate, but the use of the singular does not limit the discussion to only one of each component. For example, multiple processors may implement functionality attributed to processor 502.

Processor 502 is configured to implement functions and/or process instructions for execution within device 500. For example, processor 502 executes instructions stored in memory 504 or instructions stored on a storage device 514. In certain embodiments, instructions stored on storage device 514 are transferred to memory 504 for execution at processor 502. Memory 504, which may be a non-transient, computer-readable storage medium, is configured to store information within device 500 during operation. In some embodiments, memory 504 includes a temporary memory that does not retain information stored when the device 500 is turned off. Examples of such temporary memory include volatile memories such as random access memories (RAM), dynamic random access memories (DRAM), and static random access memories (SRAM). Memory 504 also maintains program instructions for execution by the processor 502 and serves as a conduit for other storage devices (internal or external) coupled to device 500 to gain access to processor 502.

Storage device 514 includes one or more non-transient computer-readable storage media. Storage device 514 is provided to store larger amounts of information than memory 504, and in some instances, configured for long-term storage of information. In some embodiments, the storage device 514 includes non-volatile storage elements. Non-limiting examples of non-volatile storage elements include floppy discs, flash memories, magnetic hard discs, optical discs, solid state drives, or forms of electrically programmable memories (EPROM) or electrically erasable and programmable (EEPROM) memories.

Network interfaces 506 are used to communicate with external devices and/or servers. The device 500 may comprise multiple network interfaces 506 to facilitate communication via multiple types of networks. Network interfaces 506 may comprise network interface cards, such as Ethernet cards, optical transceivers, radio frequency transceivers, or any other type of device that can send and receive information. Non-limiting examples of network interfaces 506 include radios compatible with several Wi-Fi standards, 3G, 4G, Long-Term Evolution (LTE), Bluetooth®, etc.

Power source 508 provides power to device 500. For example, device 500 may be battery powered through rechargeable or non-rechargeable batteries utilizing nickel-cadmium or other suitable material. Power source 508 may include a regulator for regulating power from the power grid in the case of a device plugged into a wall outlet, and in some devices, power source 508 may utilize energy scavenging of ubiquitous radio frequency (RF) signals to provide power to device 500.

Device 500 may also be equipped with one or more output devices 510. Output device 510 is configured to provide output to a user using tactile, audio, and/or video information. Examples of output device 510 may include a display (cathode ray tube (CRT) display, liquid crystal display (LCD) display, LCD/light emitting diode (LED) display, organic LED display, etc.), a sound card, a video graphics adapter card, speakers, magnetics, or any other type of device that may generate an output intelligible to a user.

Device 500 is equipped with one or more input devices 512. Input devices 512 are configured to receive input from a user or the environment where device 500 resides. In certain instances, input devices 512 include devices that provide interaction with the environment through tactile, audio, and/or video feedback. These may include a presence-sensitive screen or a touch-sensitive screen, a mouse, a keyboard, a video camera, microphone, a voice responsive system, or any other type of input device.

The hardware components described thus far for device 500 are functionally and communicatively coupled to achieve certain behaviors. In some embodiments, these behaviors are controlled by software running on an operating system of device 500.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for performing claim adjudication by an adherence server, the adherence server comprising a non-transitory computer readable medium and a processor to execute computer executable instructions stored on the non-transitory computer readable medium, so that when the instructions are executed, the adherence server performs the method of:
receiving adherence data describing a patient's adherence to a prescribed medication;
determining an adherence level for the patient using the received adherence data;
comparing the adherence level to an adherence threshold; and
providing, to a second device, an adherence decision based on the comparison between the adherence data and the adherence threshold.

2. The method of claim 1, wherein the receiving adherence data describing a patient's adherence to a prescribed medication comprises receiving measurement data from at least one of: (a) an asthma inhaler that tracks use; (b) a smart cap for a pill bottle; (c) an embedded pill sensor; (d) a smart pill bottle; and (e) a mobile device.

3. The method of claim 1, wherein the receiving adherence data describing a patient's adherence to a prescribed medication comprises retrieving previously calculated adherence levels or previously determined adherence decisions.

4. The method of claim 1, wherein the determining the adherence level comprises calculating the adherence level as a measure of proportion of days covered or as a medication possession ratio.

5. The method of claim 1, wherein the adherence decision is a positive adherence decision, and the method further comprises providing the adherence level and the adherence threshold to the second device.

6. The method of claim 1, wherein the adherence decision is a negative adherence decision, and the method further comprises providing non-compliance interventions such as issued recommendations, assistance and interventions to improve adherence to the prescribed medication.

7. The method of claim 6, wherein the non-compliance intervention comprises a message with a specified trial period and a specified adherence level.

8. The method of claim 1, wherein the determining an adherence level for the patient using the received adherence data is triggered by at least one selected from the group consisting of: (a) measurement by a provider or patient; (b) detecting a new claim submitted by the provider; (c) retrospective review of existing and historic claims and; and (d) periodic review.

9. The method of claim 1, wherein the adherence threshold is determined based on at least one of: (a) a type of the prescribed medication; (b) a social impact of the prescribed medication; (c) an impact of the prescribed medication to the patient; and (d) health information obtained by a healthcare provider.

10. The method of claim 1, wherein the second device is: (a) a precertification device that is configured to provide the adherence decision to a healthcare provider; or (b) a claims server that is configured to perform claims adjudication using information in a claim request and the adherence decision.

11. A non-transitory computer readable medium containing computer executable instructions for causing an adherence server performing claim adjudication to perform the method of:
receiving adherence data describing a patient's adherence to a prescribed medication;
determining an adherence level for the patient using the received adherence data;
comparing the adherence level to an adherence threshold; and
providing, to a second device, an adherence decision based on the comparison between the adherence data and the adherence threshold.

12. The non-transitory computer readable medium of claim 1, wherein the receiving adherence data describing a patient's adherence to a prescribed medication comprises receiving measurement data from at least one of: (a) an asthma inhaler that tracks use; (b) a smart cap for a pill bottle; (c) an embedded pill sensor; (d) a smart pill bottle; and (e) a mobile device.

13. The non-transitory computer readable medium of claim 11, wherein the receiving adherence data describing a patient's adherence to a prescribed medication comprises retrieving previously calculated adherence levels or previously determined adherence decisions.

14. The non-transitory computer readable medium of claim 11, wherein the determining the adherence level comprises calculating the adherence level as a measure of proportion of days covered or as a medication possession ratio.

15. The non-transitory computer readable medium of claim 11, wherein the adherence decision is a positive adherence decision, and the adherence server is further caused to perform the method of providing the adherence level and the adherence threshold to the second device.

16. The non-transitory computer readable medium of claim 11, wherein the adherence decision is a negative adherence decision, and the adherence server is further caused to perform the method of providing non-compliance interventions such as issued recommendations, assistance and interventions to improve adherence to the prescribed medication.

17. The non-transitory computer readable medium of claim 11, wherein the adherence threshold is determined based on at least one of: (a) a type of the prescribed medication; (b) a social impact of the prescribed medication; (c) an impact of the prescribed medication to the patient; and (d) health information obtained by a healthcare provider.

18. A system to perform claim adjudication, the system comprising:
an adherence server comprising a processor and a memory containing program instructions for causing the adherence server to perform the method of:
receiving adherence data describing a patient's adherence to a prescribed medication,
determining an adherence level for the patient using the received adherence data,
comparing the adherence level to an adherence threshold, and
determining an adherence decision based on the comparison between the adherence level and the adherence threshold, wherein the adherence decision comprises a positive adherence when the adherence level is greater than or equal to the adherence threshold and a negative adherence decision when the adherence level is less than the adherence threshold;
a claims server comprising a processor and a memory containing program instructions for causing the claims server to perform the method of:
receiving a claim request associated with the patient, and
performing claims adjudication using information in the claim request and the adherence decision such that when the adherence decision is a positive adherence decision the claim request is granted and when the adherence decision is a negative adherence decision the claim request is denied; and
a database configured to store the adherence data, the adherence decision, the claim request, and additional patient data.

19. The system of claim 18, further comprising:
a precertification server comprising a processor and a memory containing program instructions for causing the precertification server to perform the method of:
receiving, from a provider device, a precertification request associated with the patient, the precertification request comprising additional adherence information,
receiving, from the claims server, a denied claims request associated with the patient, and
determining whether to approve or deny the precertification request based on the denied claims request and the additional adherence information.

20. The system of claim 18, wherein the adherence data is received from (a) an asthma inhaler that tracks use; (b) a smart cap for a pill bottle; (c) an embedded pill sensor; (d) a smart pill bottle; and (e) a mobile device.
